(19) United States
(12) Patent Application Publication
(10) Pub. No.: US 2019/0010617 A1
(43) Pub. Date: Jan. 10, 2019

(54) PHOTOELECTRODE, METHOD OF MANUFACTURING THE SAME, AND PHOTOELECTROCHEMICAL REACTION DEVICE INCLUDING THE SAME

(71) Applicant: KABUSHIKI KAISHA TOSHIBA, Minato-ku (JP)

(72) Inventors: Yuki KUDO, Yokohama (JP); Satoshi Mikoshiba, Yamato (JP); Akihiko Ono, Kita (JP); Jun Tamura, Minato (JP); Eishi Tsutsumi, Kawasaki (JP); Ryota Kitagawa, Setagaya (JP); Masakazu Yamagiwa, Yokohama (JP); Yoshitsune Sugano, Kawasaki (JP)

(73) Assignee: KABUSHIKI KAISHA TOSHIBA, Minato-ku (JP)

(21) Appl. No.: 16/127,975

(22) Filed: Sep. 11, 2018

Related U.S. Application Data
(62) Division of application No. 15/414,395, filed on Jan. 24, 2017.
Application No. 15/414,395 is a continuation of application No. PCT/JP2015/004039, filed on Aug. 12, 2015.

(30) Foreign Application Priority Data
Dec. 1, 2014 (JP) 2014-243156

(51) Int. Cl. C25B 1/00; C25D 7/12; C25D 5/00; C25D 17/00; C25B 11/04; H01G 9/20; C25B 9/00; C25B 3/04; C25B 1/04; C25D 9/08; C25D 3/02

(52) U.S. Cl. CPC C25B 1/003; C25D 7/126; C25D 5/006; C25D 17/00; C25B 11/0405; Y02P 20/135; Y02E 60/366; C25B 9/00; C25B 3/04; C25B 1/04; C25D 9/08; C25B 11/04; C25D 3/02; H01G 9/20

(57) ABSTRACT

A method of manufacturing a photoelectrode of an embodiment includes: preparing a stack including a first electrode layer having a light transmitting electrode, a second electrode layer having a metal electrode, and a photovoltaic layer disposed between the electrode layers; immersing the stack in an electrolytic solution containing an ion including a metal constituting a catalyst layer which is to be formed on the first electrode layer; and passing a current to the stack through the second electrode layer to electrochemically precipitate at least one selected from the metal and a compound containing the metal, onto the first electrode layer, thereby forming the catalyst layer.

### CROSS-REFERENCE TO RELATED APPLICATIONS

This application is a continuation of prior International Application No. PCT/JP2015/004039 filed on Aug. 12, 2015, which is based upon and claims the benefit of priority from Japanese Patent Application No. 2014-243156 filed on Dec. 1, 2014; the entire contents of all of which are incorporated herein by reference.

### FIELD

Embodiments described herein generally relate to a photoelectrode, a method of manufacturing the same, and a photoelectrochemical reaction device including the same.

### BACKGROUND

Due to the recent concern about the depletion of fossil fuel such as petroleum and coal, higher expectation is placed on renewable energy that can be sustainably utilized. The development has been made on solar cells and heat power generation which use sunlight as one of the renewable energies. Unfortunately, storage batteries for storing the power (electricity) generated by the solar cell is costly and a loss occurs at the time of the storage of this power. On the other hand, a technique of converting the sunlight directly to a chemical substance (chemical energy) such as hydrogen (H₂), carbon monoxide (CO), methanol (CH₃OH), or formic acid (HCOOH) instead of converting the sunlight to electricity has been drawing attention. Storing the chemical substance (energy) converted from the sunlight in a cylinder or a tank is advantageous in that it requires less cost and involves a less loss than storing the electricity converted from the sunlight in the storage battery.

As a device that converts solar energy to chemical energy, a photoelectrochemical reaction device in which a photovoltaic part and an electrolytic part are integrated is known. The photoelectrochemical reaction device includes a photovoltaic cell having, for example, an oxidation electrode which oxidizes water (H₂O), a reduction electrode which reduces carbon dioxide (CO₂), and a photovoltaic layer where charge separation is caused by light energy. For example, in the oxidation electrode, oxygen (O₂) and hydrogen ions (4H⁺) are generated through the oxidation of water (2H₂O) by the light energy. For example, the reduction electrode reduces CO₂ by receiving the hydrogen ions (4H⁺) from the oxidation electrode to generate a chemical substance such as formic acid (HCOOH). Photoelectrochemical reaction devices are roughly classified into cell-integrated devices whose photovoltaic cell is not immersed in an electrolytic solution but is integrated on an electrolytic bath and cell-immersed devices whose photovoltaic cell is immersed in an electrolytic solution.

Some cell-immersed photoelectrochemical reaction device includes a photoelectrode having a catalyst layer which is formed on an electrode layer of its photovoltaic cell by an electrochemical method, to promote an electrochemical reaction of water (H₂O) or carbon dioxide (CO₂). The electrochemical method immerses the electrode in a solution containing a substance forming the catalyst layer and passes a current to the electrode to form the catalyst layer on the electrode layer by an electrochemical reaction. The electrode layer on a light incident side is formed of a conductive substance having a light transmitting property, for example, a conductive oxide such as indium tin oxide (ITO) or zinc oxide (ZnO). The conductive oxide has a high sheet resistance of about 10 to 30Ω/□, and thus when the catalyst layer is formed by the electrochemical method, potential distribution occurs in a surface of the electrode layer formed of the conductive oxide. This causes thickness nonuniformity of the catalyst layer, and as the catalyst layer has a larger area, its thickness is more likely to be nonuniform. The thickness nonuniformity of the catalyst layer results in a nonuniform light transmitting property of the photoelectrode and a nonuniform electrochemical reaction, deteriorating conversion efficiency from the sunlight to chemical energy.

### BRIEF DESCRIPTION OF THE DRAWINGS

FIG. 1A is a cross-sectional view illustrating a step of manufacturing a photoelectrode according to a first embodiment.

FIG. 1B is a cross-sectional view illustrating a step of manufacturing the photoelectrode according to the first embodiment.

FIG. 2 is a view illustrating a catalyst layer forming device used in the steps of manufacturing the photoelectrode of the embodiment.

FIG. 3 is a cross-sectional view illustrating a first configuration example of a stack in the photoelectrode of the first embodiment.

FIG. 4 is a cross-sectional view illustrating a second configuration example of the stack in the photoelectrode of the first embodiment.

FIG. 5 is a cross-sectional view illustrating a preparation step before the catalyst layer is formed on the stack in the first embodiment.

FIG. 6 is an equivalent circuit diagram of a step of forming the catalyst layer in the first embodiment.

FIG. 7 is a chart illustrating an example of a temporal variation of a current when the catalyst layer is formed, in the first embodiment.

FIG. 8 is a photograph illustrating a formation state of the thin-film catalyst layer according to the first embodiment.

FIG. 9 is a cross-sectional view schematically illustrating the photoelectrode including the catalyst layer formed by the first embodiment.

FIG. 10 is a chart illustrating an example of a temporal variation of a current when a catalyst layer is formed, in a comparative example.

FIG. 11 is a photograph illustrating a formation state of the thin-film catalyst layer according to the comparative example.

FIG. 12 is a cross-sectional view schematically illustrating a photoelectrode including the catalyst layer formed by the comparative example.

FIG. 13A is a cross-sectional view illustrating a step of manufacturing a photoelectrode according to a second embodiment.

FIG. 13B is a cross-sectional view illustrating a step of manufacturing the photoelectrode according to the second embodiment.

FIG. 14 is a cross-sectional view illustrating a first configuration example of a stack in the photoelectrode of the second embodiment.

FIG. 15 is a cross-sectional view illustrating a second configuration example of the stack in the photoelectrode of the second embodiment.

FIG. 16 is an equivalent circuit diagram of a step of forming a catalyst layer in the second embodiment.

FIG. 17 is a view illustrating a first configuration example of a photoelectrochemical reaction device according to an embodiment.

FIG. 18 is a view illustrating a second configuration example of the photoelectrochemical reaction device according to the embodiment.

### DETAILED DESCRIPTION

A method for manufacturing a photoelectrode of an embodiment includes: preparing a stack including a first electrode layer having a light transmitting electrode, a second electrode layer having a metal electrode, and a photovoltaic layer disposed between the first electrode layer and the second electrode layer; immersing the stack in an electrolytic solution containing an ion including a metal constituting at least part of a catalyst layer which is to be formed on the first electrode layer; and passing a current to the stack immersed in the electrolytic solution through the second electrode layer to electrochemically precipitate at least one selected from the group consisting of the metal and a compound containing the metal, onto the first electrode layer.

Photoelectrodes of embodiments, methods of manufacturing the same, and a photoelectrochemical reaction device of an embodiment will be hereinafter described with reference to the drawings. In the embodiments, substantially the same constituent parts are denoted by the same reference signs, and description thereof may be partly omitted. The drawings are schematic, and a relation of the thickness and the planar dimension, a thickness ratio of parts, and so on are sometimes different from actual ones.

### First Embodiment

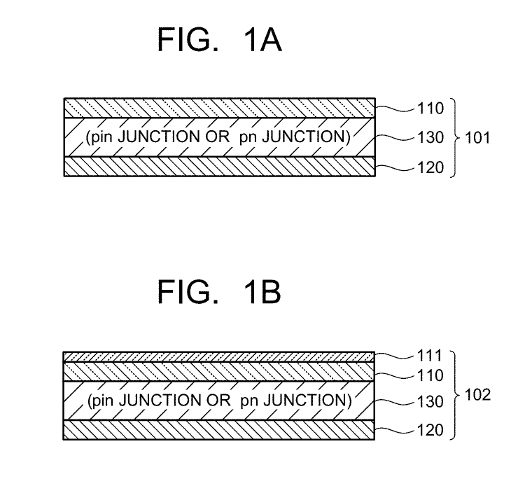

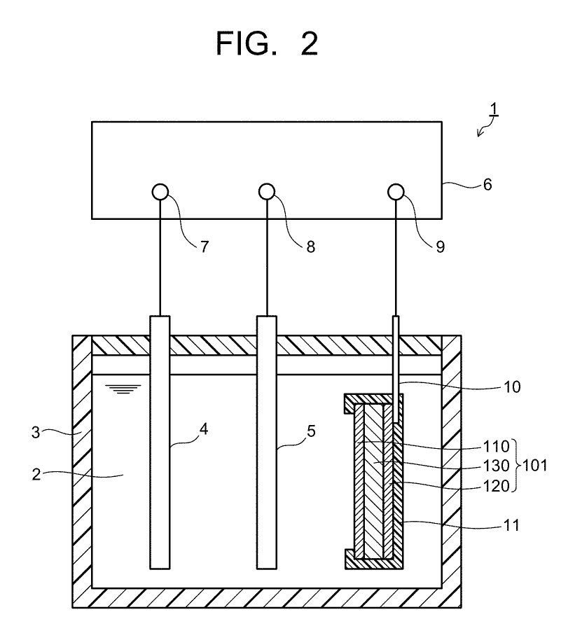

FIG. 1A and FIG. 1B are cross-sectional views illustrating steps of manufacturing a photoelectrode according to a first embodiment. FIG. 2 is a view illustrating a catalyst layer forming device used in the steps of manufacturing the photoelectrode of the embodiment. As illustrated in FIG. 1A, a stack 101 including a first electrode layer 110, a second electrode layer 120, and a photovoltaic layer 130 between the electrode layers 110, 120 is prepared. As illustrated in FIG. 1B, a first catalyst layer 111 is formed on the first electrode layer 110, whereby a photoelectrode 102 is fabricated. A second catalyst layer, not illustrated here, is formed on the second electrode layer 120 as required. To form the first catalyst layer 111, the catalyst layer forming device 1 illustrated in FIG. 2 is used. A step of forming the first catalyst layer 111 will be described in detail later.

The stack 101 and the photoelectrode 102 each have a flat plate shape extending in a first direction and a second direction perpendicular to the first direction. To form the stack 101, the photovoltaic layer 130 and the first electrode layer 110 are formed in sequence on, for example, the second electrode layer 120 as a substrate. To form the photoelectrode 102, the first catalyst layer 111 is formed on the first electrode layer 110 of the stack 101. In the photovoltaic layer 130, charge separation is caused by energy of irradiating light such as sunlight or illumination light. In the first embodiment, a surface of the photovoltaic layer 130 where the first electrode layer 110 is formed is an irradiating light receiving surface. In the photoelectrode 102 of the first embodiment, the first electrode layer 110 on the light-receiving surface side is an oxidation electrode, and the second electrode layer 120 opposite to the light-receiving surface is a reduction electrode.

The photovoltaic layer 130 of the first embodiment is a solar cell having pin junction or pn junction of semiconductors, for instance. It may be a different solar cell. Semiconductor layers forming the photovoltaic layer 130 each may be formed of a semiconductor such as Si, Ge, or Si—Ge or a compound semiconductor such as GaAs, GaInP, AlGaInP, CdTe, CuIn, or GaSe. The semiconductor forming the semiconductor layer may be in any of various forms such as monocrystalline and amorphous forms. The photovoltaic layer 130 is preferably a multijunction photovoltaic layer composed of a stack of two or more photoelectric conversion layers (solar cells) in order to have a high open-circuit voltage.

The surface of the photovoltaic layer 130 where the first electrode layer 110 is formed is the light-receiving surface and thus the first electrode layer 110 has a light transmitting electrode (also called a transparent electrode) formed of, for example, a transparent conductive oxide (to be described in detail later). Where the first electrode layer 110 is the oxidation electrode and the second electrode layer 120 is the reduction electrode, the photovoltaic layer 130 has pin junction of a p-type semiconductor layer on the first electrode layer 110 side, an n-type semiconductor layer on the second electrode layer 120 side, and an i-type semiconductor layer between the p-type semiconductor layer and the n-type semiconductor layer, or pn junction of a p-type semiconductor layer on the first electrode layer 110 side and an n-type semiconductor layer on the second electrode layer 120 side.

Light irradiating the photovoltaic layer 130 through the first electrode layer 110 causes the charge separation in the photovoltaic layer 130, resulting in the generation of an electromotive force. Electrons migrate to the second electrode layer 120 on the n-type semiconductor layer side, and holes generated as pairs with the electrons migrate to the first electrode layer 110 on the p-type semiconductor layer side. Near the first electrode layer 110 to which the holes migrate, an oxidation reaction of water (H₂O) occurs, and near the second electrode layer 120 to which the electrons migrate, a reduction reaction of at least one of carbon dioxide (CO₂) and water (H₂O) occurs. Accordingly, in the photoelectrode 102 whose photovoltaic layer 130 includes the pin junction or the pn junction, the first electrode layer 110 is the oxidation electrode, and the second electrode layer 120 is the reduction electrode.

The first catalyst layer 111 on the first electrode layer 110 which is the oxidation electrode enhances chemical reactivity near the first electrode layer 110, that is, oxidation reactivity. Where the second catalyst layer is formed on the second electrode layer 120, the second catalyst layer enhances chemical reactivity near the second electrode layer 120, that is, reduction reactivity. The effects of the catalyst layers to promote the oxidation-reduction reaction can reduce overvoltages of the oxidation-reduction reaction. This enables the more effective use of the electromotive force generated in the photovoltaic layer 130.

Near the first electrode layer 110, O₂ and H⁺ are generated through the oxidation of H₂O, for instance. Accordingly, the first catalyst layer 111 is formed of a material that reduces activation energy for oxidizing H₂O. In other words, this material lowers the overvoltage at the time of the generation of O₂ and H⁺ through the oxidation of H₂O. Example of such a material include oxides including at least one metal selected from manganese (Mn), iridium (Ir), nickel (Ni), cobalt (Co), iron (Fe), tin (Sn), indium (In), ruthenium (Ru), lanthanum (La), strontium (Sr), lead (Pb), and titanium (Ti). The first catalyst layer 111 has a thin-film form, for instance.

Specific examples of an oxidation catalyst which forms the first catalyst layer 111 include binary metal oxides such as manganese oxide (Mn—O), iridium oxide (Ir—O), nickel oxide (Ni—O), cobalt oxide (Co—O), iron oxide (Fe—O), tin oxide (Sn—O), indium oxide (In—O), and ruthenium oxide (Ru—O), ternary metal oxides such as Ni—Co—O, Ni—Fe—O, La—Co—O, Ni—La—O, Sr—Fe—O, and Fe—Co—O, and quaternary metal oxides such as Pb—Ru—Ir—O and La—Sr—Co—O.

Near the second electrode layer 120, a carbon compound (for example, CO, HCOOH, CH₄, CH₃OH, C₂H₅OH, C₂H₄) is generated through the reduction of CO₂, for instance. Where the second catalyst layer is formed on the second electrode layer 120, the second catalyst layer is formed of a material that reduces activation energy for reducing CO₂. In other words, this material lowers the overvoltage at the time of the generation of the carbon compound through the reduction of CO₂. Examples of such a material include at least one metal selected from gold (Au), silver (Ag), copper (Cu), platinum (Pt), palladium (Pd), nickel (Ni), zinc (Zn), cadmium (Cd), indium (In), tin (Sn), cobalt (Co), iron (Fe), and lead (Pb), an alloy containing such a metal, carbon materials such as carbon (C), graphene, CNT (carbon nanotube), fullerene, and ketjen black, and metal complexes such as a Ru complex and a Re complex. The form of the second catalyst layer is not limited to the thin-film form but may be an island form, a lattice form, a particulate form, or a wire form.

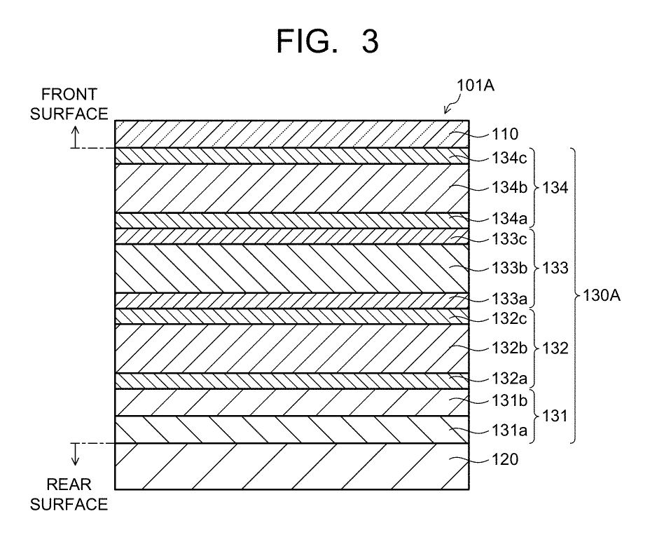

Specific configuration examples of the photovoltaic layer 130 and the stack 101 including the same will be described with reference to FIG. 3 and FIG. 4. FIG. 3 illustrates a stack 101A whose photovoltaic layer 130A is a pin junction silicon-based solar cell. The stack 101A illustrated in FIG. 3 is composed of a first electrode layer 110, the photovoltaic layer 130A, and a second electrode layer 120. The second electrode layer 120 has conductivity and examples of its material include metals such as copper (Cu), aluminum (Al), titanium (Ti), nickel (Ni), iron (Fe), and silver (Ag) and an alloy containing at least one of these metals. The second electrode layer 120 also has a function as a support substrate to maintain mechanical strength of the stack 101A and the photoelectrode 102. The second electrode layer 120 is a metal plate or an alloy plate of the aforesaid material.

The photovoltaic layer 130A is on the second electrode layer 120. The photovoltaic layer 130A is composed of a reflection layer 131, a first photovoltaic layer 132, a second photovoltaic layer 133, and a third photovoltaic layer 134. The reflection layer 131 is on the second electrode layer 120 and has a first reflection layer 131a and a second reflection layer 131b in sequence from the lower side. The first reflection layer 131a is formed of a light transmitting and conductive material, and examples of the material include metals such as silver (Ag), gold (Au), aluminum (Al), and copper (Cu), and an alloy containing at least one of these metals. The second reflection layer 131b enhances light reflectivity by adjusting an optical distance. The second reflection layer 131b is joined with an n-type semiconductor layer of the photovoltaic layer 130A and thus is preferably formed of a material having a light transmitting property and capable of ohmic contact with the n-type semiconductor layer. Examples of the material of the second reflection layer 131b include transparent conductive oxides such as indium tin oxide (ITO), fluorine-doped tin oxide (FTO), antimony-doped tin oxide (ATO), zinc oxide (ZnO), and aluminum-doped zinc oxide (AZO).

The first photovoltaic layer 132, the second photovoltaic layer 133, and the third photovoltaic layer 134 are pin-junction solar cells and are different in light absorption wavelength. With these layers stacked in a planar state, the photovoltaic layer 130A can absorb lights in a wide wavelength range of the sunlight, enabling the efficient use of energy of the sunlight. The photovoltaic layer 130A includes the series-connected photovoltaic layers 132, 133, 134 and thus can have a high open-circuit voltage.

The first photovoltaic layer 132 is on the reflection layer 131 and has an n-type amorphous silicon (a-Si) layer 132a, an intrinsic amorphous silicon germanium (a-SiGe) layer 132b, and a p-type microcrystalline silicon layer (μc-Si) layer 132c in sequence from the lower side. The a-SiGe layer 132b absorbs light in a long wavelength range of about 700 nm. In the first photovoltaic layer 132, charge separation is caused by energy of the light in the long wavelength range.

The second photovoltaic layer 133 is on the first photovoltaic layer 132 and has an n-type a-Si layer 133a, an intrinsic a-SiGe layer 133b, and a p-type μc-Si layer 133c in sequence from the lower side. The a-SiGe layer 133b absorbs light in a middle wavelength range of about 600 nm. In the second photovoltaic layer 133, charge separation is caused by energy of the light in the middle wavelength range.

The third photovoltaic layer 134 is on the second photovoltaic layer 133 and has an n-type a-Si layer 134a, an intrinsic a-Si layer 134b, and a p-type μc-Si layer 134c in sequence from the lower side. The a-Si layer 134b absorbs light in a short wavelength range of about 400 nm. In the third photovoltaic layer 134, charge separation is caused by energy of the light in the short wavelength range.

The first electrode layer 110 is on the p-type semiconductor layer (p-type μc-Si layer 134c) of the photovoltaic layer 130A. The first electrode layer 110 preferably contains a material having a light transmitting property and capable of ohmic contact with the p-type semiconductor layer. Examples of the material of the first electrode layer 110 include transparent conductive oxides such as indium tin oxide (InSnOₓ; ITO), zinc oxide (ZnOₓ), aluminum-doped zinc oxide (AZO), tin oxide (SnOₓ), fluorine-doped tin oxide (FTO), antimony-doped tin oxide (ATO), indium zinc oxide (IZO), and indium gallium zinc oxide (IGZO). The first electrode layer 110 is not limited to a single layer of the transparent conductive oxide but may be, for example, a stack of the transparent conductive oxide layer and a metal layer or a layer of a composite of the transparent conductive oxide and another conductive material.

FIG. 4 illustrates a stack 101B whose photovoltaic layer 130B is a pn-junction silicon-based solar cell. The stack 101B illustrated in FIG. 4 is composed of a first electrode layer 110, the photovoltaic layer 130B, and a second electrode layer 120. The functions, constituent materials, and so on of the first electrode layer 110 and the second electrode layer 120 are the same as those of the stack 101A illustrated in FIG. 3. The photovoltaic layer 130B has an n⁺-type silicon (n⁺-Si) layer 135a, an n-type silicon (n-Si) layer 135b, a p-type silicon (p-Si) layer 135c, and a p⁺-type silicon (p⁺-Si) layer 135d formed on the second electrode layer 120 in sequence.

In the photoelectrode 102 including the stack 101A illustrated in FIG. 3 or the stack 101B illustrated in FIG. 4, the irradiating light passes through the first electrode layer 110 to reach the photovoltaic layer 130A, 130B. The first electrode layer 110 on the light irradiated side (upper side in FIG. 3 and FIG. 4) has a property of transmitting the irradiating light. The first electrode layer 110 has the light transmitting electrode. The first electrode layer 110 preferably transmits 10% or more and more preferably 30% or more of an irradiation amount of the irradiating light. The first electrode layer 110 may have an aperture for the light transmission. The open area ratio of the first electrode layer 110 in this case is preferably 10% or more and more preferably 30% or more. The first electrode layer 110 may have a collector electrode having, for example, a line shape, a lattice shape, or a honeycomb shape on at least part thereof in order to have higher conductivity while maintaining the light transmitting property.

In the description in FIG. 3, the photovoltaic layer 130A having the stacked structure of the three photovoltaic layers 132, 133, 134 is taken as an example, but the photovoltaic layer 130 is not limited to this. The photovoltaic layer 130 may have a stacked structure of two, or four or more photovoltaic layers. The photovoltaic layer may be the single photovoltaic layer 130 instead of the photovoltaic layer 130A having the stacked structure. The same applies to the photovoltaic layer 130B illustrated in FIG. 4 and it may have a stacked structure of two or more photovoltaic layers. The semiconductors of the semiconductor layers forming the photovoltaic layer 130 each are not limited to Si or Ge, but may be a compound semiconductor such as, for example, GaAs, GaInP, AlGa, InP, CdTe, CuInGaSe, GaP, or GaN.

A method for forming the first catalyst layer 111 on the first electrode layer 110 of the stack 101 will be described. The first catalyst layer 111 is electrochemically formed using the catalyst layer forming device 1 illustrated in FIG. 2. The catalyst layer forming device 1 illustrated in FIG. 2 has an electrolytic solution bath 3 storing an electrolytic solution 2. In the electrolytic solution 2 filled in the electrolytic solution bath 3, a counter electrode 4 and a reference electrode 5 are immersed. The stack 101 where to form the first catalyst layer 111 is immersed in the electrolytic solution 2 and is a working electrode opposed to the counter electrode 4. The catalyst layer forming device 1 includes a potentiostat as a power source 6 used for an electrochemical reaction. The counter electrode 4 is electrically connected to a counter electrode terminal 7 of the power source 6, and the reference electrode 5 is electrically connected to a reference electrode terminal 8 of the power source 6. The stack 101 is electrically connected to a working electrode terminal 9 of the power source 6 by a wiring member 10.

The counter electrode 4 is formed of an electrochemically stable material such as platinum (Pt), gold (Au), or stainless steel (SUS). The reference electrode 5 serves as a potential reference at the time of the electrochemical reaction and is, for example, a silver-silver chloride electrode or a calomel electrode. The electrolytic solution 2 contains ions including a metal which forms at least part of the first catalyst layer 111 (hereinafter, also referred to as a catalyst forming metal). The electrolytic solution 2 is an aqueous solution having electrical conduction, in which at least one kind of cations selected from ions of the catalyst forming metal, oxide ions of the catalyst forming metal, and complex ions of the catalyst forming metal and at least one kind of anions selected from inorganic acid ions and hydroxide ions are dissolved. The electrolytic solution 2 may contain, for example, a supporting electrolyte.

The catalyst layer forming device 1 forms the first catalyst layer 111 by passing a current between the stack 101 and the counter electrode 4 which are immersed in the electrolytic solution 2, from the power source 6 and electrochemically precipitating at least one selected from the catalyst forming metal and a compound containing the catalyst forming metal onto the first electrode layer 110 of the stack 101. In forming the first catalyst layer 111, the current flowing between the stack 101 and the counter electrode 4 is controlled by the current source (potentiostat) 6, for instance. In forming the first catalyst layer 111 on the first catalyst electrode layer 110, a potential applied across the stack 101 and the reference electrode 5 may be controlled.

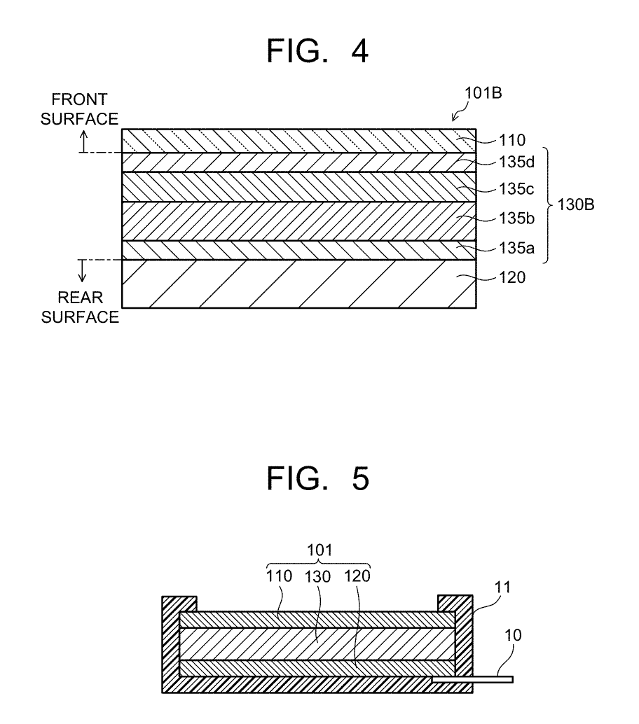

To form the first catalyst layer 111 on the first electrode layer 110 using the catalyst layer forming device 1 illustrated in FIG. 2, the wiring member 10 for leading the current is connected to the stack 101 as illustrated in FIG. 5. The material of the first electrode layer 110 of the stack 101 is the transparent conductive oxide having a high sheet resistance of about 10 to about 30Ω/□, while the material of the second electrode layer 120 is a metal material having a low sheet resistance of about several to about several ten mΩ/□. Where the stack 101 has an about 10×30 mm, for instance, the first electrode layer 110 has a high resistance of about 50Ω, while the second electrode layer 120 has a low resistance of about 10 mΩ. Accordingly, connecting the wiring member 10 to the first electrode layer 110 would cause potential distribution in a surface of the first electrode layer 110 when the first catalyst layer 111 is electrochemically formed. The potential distribution in the surface of the first electrode layer 110 causes thickness nonuniformity of the first catalyst layer 111. The thickness nonuniformity of the first catalyst layer 111 caused by the potential distribution is likely to occur when a longitudinal length of the stack 101 is over 10 mm if a short-side length of the stack 101 is 10 mm.

As illustrated in FIG. 5, the wiring member 10 leading the current to the stack 101 is connected to the second electrode layer 120. The wiring member 10 is formed of a highly conductive member and a covering material. By connecting the wiring member 10 to the low-resistance second electrode layer 120, the potential is uniformly given to the first electrode layer 110 from the low-resistance second electrode layer 120 when the first catalyst layer 111 is electrochemically formed. This enables the formation of the first catalyst layer 111 having the in-plane uniformity on the first electrode layer 110. The wiring member 10 connected to the second electrode layer 120 effectively works on the stack 101 having, for example, a 10 mm short-side length and a more than 10 mm or 20 mm or more longitudinal length. Outer peripheral surfaces of the stack 101 are covered with a protective member 11 except a part of the first electrode layer 110 where to form the first catalyst layer 111. The protective member 11 is preferably formed of, for example, resin having high electrical insulation. The protective member 11 insulates the outer peripheral surfaces of the stack 101 except the part where to form the first catalyst layer 111 from the electrolytic solution 2.

Next, the electrolytic solution 2 is prepared. Where the first catalyst layer 111 formed of the oxidation catalyst is formed on the first electrode layer 110, the electrolytic solution 2 is preferably an aqueous solution containing: at least one kind of ions selected from the ions of the catalyst forming metal, the oxide ions of the catalyst forming metal, and the complex ions of the catalyst forming metal; and the inorganic acid ions. The inorganic acid ions are preferably at least one kind of ions selected from nitric acid ions (NO₃⁻), sulfuric acid ions (SO₄²⁻), chloride ions (Cl⁻), phosphoric acid ions (PO₄²⁻), boric acid ions (BO₃³⁻), hydrogen carbonate ions (HCO₃⁻), and carbonate ions (CO₃²⁻). To adjust the conductivity of the electrolytic solution 2, a supporting electrolyte formed of sodium ions, (Na⁺), potassium ions (K⁺), calcium ions (Ca²⁺), lithium ions (Li⁺), cesium ions (Cs⁺), magnesium ions (Mg²⁺), or chlorine ions (Cl⁻) may be contained in the electrolytic solution 2.

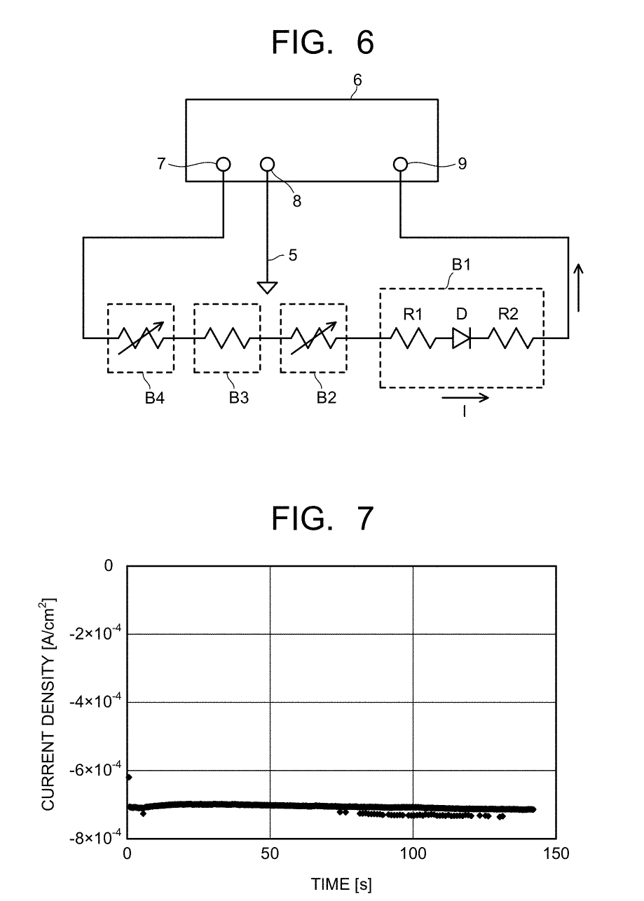

The counter electrode 4, the reference electrode 5, and the stack 101 connected to the respective terminals 7, 8, 9 of the power source 6 are disposed in the electrolytic solution bath 3 filled with the electrolytic solution 2. While the counter electrode 4, the reference electrode 5, and the stack 101 are immersed in the electrolytic solution 2, the current is led to the stack 101 through the wiring member 10 connected to the second electrode layer 120. FIG. 6 is an equivalent circuit diagram of the step of forming the first catalyst layer 111 using the catalyst layer forming device 1. In FIG. 6, a block B1 is an equivalent circuit of the stack (photovoltaic cell) 101, a block B2 is an equivalent circuit representing an electrode reaction on the first electrode layer 110, a block B3 is an equivalent circuit representing the resistance of the electrolytic solution 2, a block B4 is an equivalent circuit representing an electrode reaction on the counter electrode 4, R1 is the resistance of the first electrode layer 110, R2 is the resistance of the second electrode layer 120, and D is the photovoltaic layer 130. Where the photovoltaic layer 130 has a plurality of pin junctions or pn junctions, the equivalent circuit of the photovoltaic layer 130 is series connection of a plurality of diodes, but in FIG. 6, the plural series-connected diodes are equivalently represented by one diode.

As illustrated in FIG. 6, a forward bias is applied to the photovoltaic layer (diode) D to control the power source (potentiostat) 6 so that a forward current (indicated by the arrow in FIG. 6) flows in the photovoltaic layer D. That is, the current is passed between the counter electrode 4 and the stack 101 whose polarity is negative. The direction of the current is negative. When such a negative current is passed, at least one of the inorganic acid ions, water (H₂O), and dissolved oxygen (O₂) is reduced around the stack 101 whose polarity is negative, so that hydroxide ions (OFF) are generated. From the generated hydroxide ions (OFF) and at least one kind of ions selected from metal ions, metal oxide ions, and metal complex ions, at least one selected from a hydroxide and an oxide of the aforesaid metal is precipitated onto the first electrode layer 110. The metal hydroxide precipitated onto the first electrode layer 110 is thereafter heat-treated to be converted to a metal oxide. The metal oxide may be generated through the precipitation of the metal onto the first electrode layer 110 under a varied current or potential and subsequent heat-treatment of the metal.

As a specific example of forming the first catalyst layer 111, an example where the first catalyst layer 111 formed of cobalt oxide (CoOₓ) was formed on the first electrode layer 110 will be hereinafter described. The electrolytic solution 2 was an aqueous solution (concentration: 0.01 M) of cobalt nitrate (Co(NO₃)₂). The cobalt nitrate in the aqueous solution is dissociated into cobalt ions (Co²⁺) and nitric acid ions (NO₃⁻). The wiring member 10 connected to the second electrode layer 120 of the stack 101 having an area of 10×30 mm was connected to the working electrode terminal 9 of the power source (potentiostat) 6, a negative current of about −0.7 mA/cm² was passed, and the catalyst layer 111 was formed on the first electrode layer 110. The formation of the catalyst layer 111 was continued until a coulomb reached 100 mC/cm². FIG. 7 illustrates a temporal variation of the current when the catalyst layer 111 is formed.

The formation mechanism of the catalyst layer 111 is as follows. The nitric acid ions (NO₃⁻) in the electrolytic solution 2 are reduced, so that the hydroxide ions (OH) are generated near the first electrode layer 110 as expressed by the following formula (1). The generation of the hydroxide ions (OH) results in an increase of pH near the first electrode layer 110, so that cobalt hydroxide (Co(OH)₂) is precipitated onto the first electrode layer 110 from the cobalt ions (Co²⁺) and the hydroxide ions (OH) as expressed by the following formula (2).

NO₃⁻+H₂O+2e⁻→NO₂⁻+2OH⁻ (1)

Co²⁺+2OH⁻→Co(OH)₂ (2)

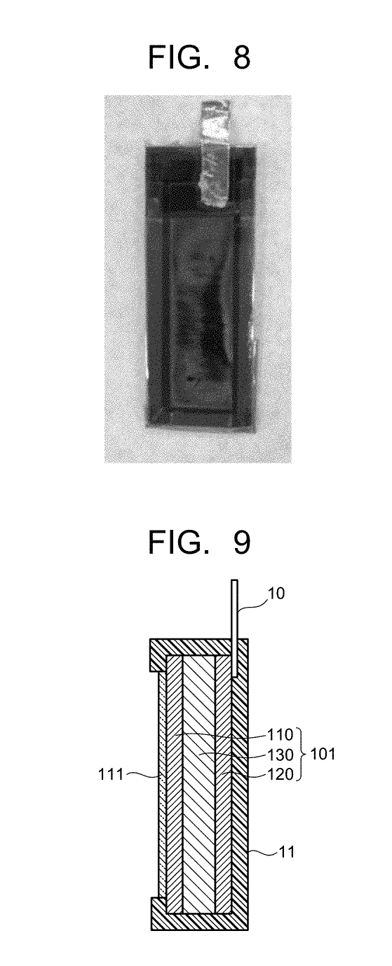

The stack 101 in which the cobalt hydroxide (Co(OH)₂) was precipitated was taken out from the electrolytic solution bath 3 and thereafter heat-treated in the air using an electric furnace under the condition of 180° C.×thirty minutes, so that the cobalt hydroxide (Co(OH)₂) was converted into cobalt oxide (CoOₓ). FIG. 8 is a photograph of the heat-treated stack 101 taken from the first electrode layer 110 side and illustrates the catalyst layer 111 formed in a thin-film form on the first electrode layer 110. In FIG. 8, the wiring member was connected to the second electrode layer from above to lead the current. FIG. 9 is a cross-sectional view schematically illustrating a state after the formation of the catalyst layer 111. From FIG. 8, it is seen that the cobalt oxide (CoOₓ), whose formation part is gray-colored, is formed favorably also in the longitudinal direction.

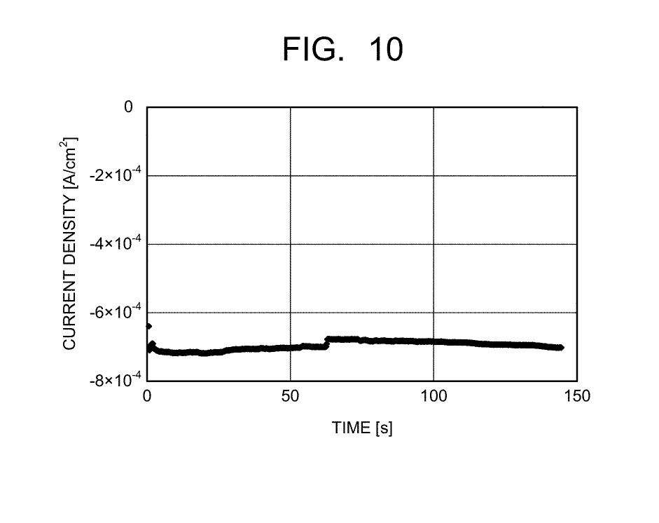

As a comparative example to the above-described embodiment, a catalyst layer was formed on a first electrode layer while a current was passed through a wiring member connected to the first electrode layer. An electrolytic solution used was the same as that of the above-described specific example of the embodiment. The wiring member connected to the first electrode layer of a stack having an area of 10×30 mm was connected to a working electrode terminal of a power source (potentiostat) to pass a negative current of about −0.7 mA/cm², whereby cobalt hydroxide (Co(OH)₂) was precipitated onto the first electrode layer. The precipitation of the cobalt hydroxide was continued until a coulomb reached 100 mC/cm². FIG. 10 illustrates a temporal variation of the current when the cobalt hydroxide is precipitated.

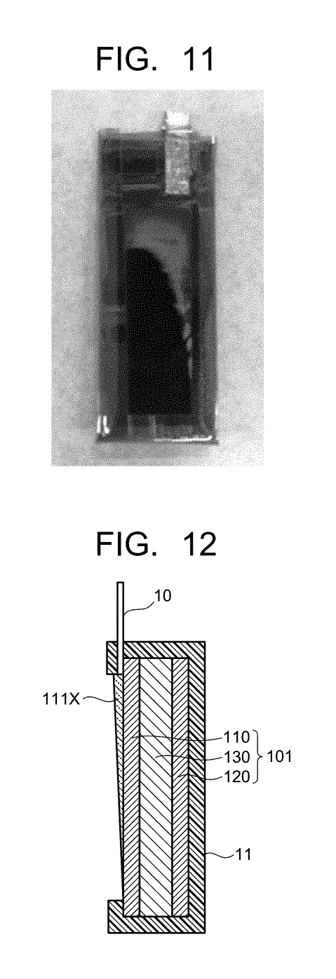

The stack in which the cobalt hydroxide (Co(OH)₂) was precipitated was taken out from the electrolytic solution bath and thereafter heat-treated in the air using an electric furnace under the condition of 180° C.×thirty minutes, so that the cobalt hydroxide (Co(OH)₂) was converted into cobalt oxide (CoOₓ). FIG. 11 is a photograph of the heat-treated stack of the comparative example taken from the first electrode layer side and illustrates the catalyst layer formed on the first electrode layer. In FIG. 11, the wiring member was connected to the first electrode layer from above to lead the current. FIG. 12 is a cross-sectional view schematically illustrating a state after the formation of the catalyst layer. In FIG. 11, the gray area where the cobalt oxide (CoOₓ) is formed is biased to an upper portion close to the wiring member and a cobalt oxide (CoOₓ) layer is formed nonuniformly in the longitudinal direction in the surface. This is thought to be because the transparent conductive oxide which forms the first electrode layer has a high resistance and thus potential distribution occurs when the current is led.

As described above, in the first embodiment, the photovoltaic layer 130 is forward-biased, which allows the wiring member 10 to be connected to the second electrode layer 120. The current is led to the stack 101 through the wiring member 10 connected to the second electrode layer 120 lower in resistance than the first electrode layer 110, making it possible to electrochemically form the first catalyst layer 111 having excellent in-plane thickness uniformity, on the first electrode layer 110. The increase of the thickness uniformity of the first catalyst layer 111 results in a uniform light transmitting property of the photoelectrode 102 and uniform electrochemical reactivity. Using such a photoelectrode 102 makes it possible to provide a photoelectrochemical reaction device excellent in conversion efficiency from energy of irradiating light such as the sunlight to chemical energy. Here, the steps of forming the first catalyst layer 111 have been described, but the wiring member 10 connected to the second electrode layer 120 may be used to form, for example, a metal layer or a metal oxide layer other than the catalyst layer 111.

### Second Embodiment

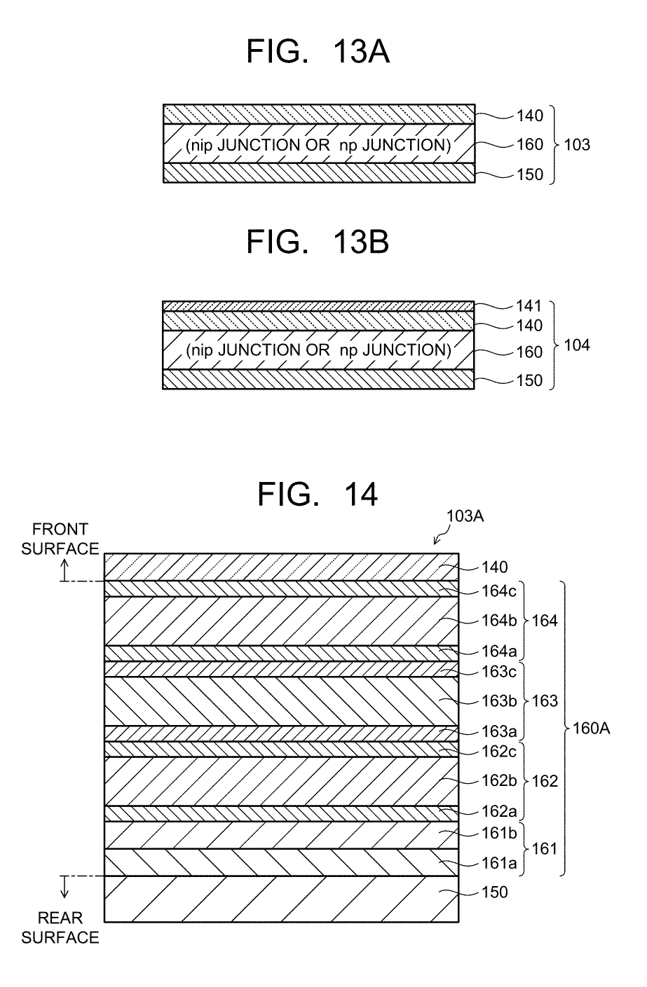

Next, steps of manufacturing a photoelectrode according to a second embodiment will be described. As illustrated in FIG. 13A, a stack 103 including a first electrode layer 140, a second electrode layer 150, and a photovoltaic layer 160 between the electrode layers 140, 150 is prepared. As illustrated in FIG. 13B, a first catalyst layer 141 is formed on the first electrode layer 140, whereby a photoelectrode 104 is fabricated. A second catalyst layer, not illustrated here, is formed on the second electrode layer 150 as required. The first catalyst layer 141 is formed using the catalyst layer forming device 1 illustrated in FIG. 2. A step of forming the first catalyst layer 141 will be described in detail later.

The stack 103 and the photoelectrode 104 each have a flat plate shape extending in a first direction and a second direction perpendicular to the first direction. To form the stack 103, the photovoltaic layer 160 and the first electrode layer 140 are formed in sequence on, for example, the second electrode layer 150 as a substrate. To form the photoelectrode 104, the first catalyst layer 141 is formed on the first electrode layer 140 of the stack 103. In the photovoltaic layer 160, charge separation is caused by energy of irradiating light such as sunlight or illumination light. In the second embodiment, a surface of the photovoltaic layer 160 where the first electrode layer 140 is formed is an irradiating light receiving surface. In the photoelectrode 104 of the second embodiment, the first electrode layer 140 on the light-receiving surface side is a reduction electrode, and the second electrode layer 150 opposite to the light-receiving surface is an oxidation electrode.

The surface of the photovoltaic layer 160 where the first electrode layer 140 is formed is the light-receiving surface and thus the first electrode layer 140 has a light transmitting electrode formed of, for example, a transparent conductive oxide. Where the first electrode layer 140 is the reduction electrode and the second electrode layer 150 is the oxidation electrode, the photovoltaic layer 160 is a solar cell having nip junction or np junction of semiconductors, for instance. Specifically, the photovoltaic layer 160 includes the nip junction of an n-type semiconductor layer on the first electrode layer 140 side, a p-type semiconductor layer on the second electrode layer 150 side, and an i-type semiconductor layer between the n-type semiconductor layer and the p-type semiconductor layer, or the np junction of an n-type semiconductor layer on the first electrode layer 140 side and a p-type semiconductor layer on the second electrode layer 150 side.

Light irradiating the photovoltaic layer 160 through the first electrode layer 140 causes charge separation in the photovoltaic layer 160, resulting in the generation of an electromotive force. Electrons migrate to the first electrode layer 140 on the n-type semiconductor layer side, and holes generated as pairs with the electrons migrate to the second electrode layer 150 on the p-type semiconductor layer side. Near the second electrode layer 150 to which the holes migrate, an oxidation reaction of water (H₂O) occurs, and near the first electrode layer 140 to which the electrons migrate, a reduction reaction of at least one of carbon dioxide (CO₂) and water (H₂O) occurs. Accordingly, in the photoelectrode 104 whose photovoltaic layer 160 includes the nip junction or the np junction, the first electrode layer 140 is the reduction electrode, and the second electrode layer 150 is the oxidation electrode.

The first catalyst layer 141 on the first electrode layer 140 which is the reduction electrode enhances chemical reactivity near the first electrode layer 140, that is, reduction reactivity. Where the second catalyst layer is formed on the second electrode layer 150, the second catalyst layer enhances chemical reactivity near the second electrode layer 150, that is, oxidation reactivity. The effect of the catalyst layers to promote the oxidation-reduction reaction can reduce overvoltages of the oxidation-reduction reaction. This enables the more effective use of the electromotive force generated in the photovoltaic layer 160.

Near the first electrode layer 140, a carbon compound (for example, CO, HCOOH, CH₄, CH₃OH, C₂H₅OH, C₂H₄) is generated through the reduction of CO₂, for instance. Accordingly, the first catalyst layer 141 is formed of a material that reduces activation energy for reducing CO₂. In other words, this material lowers the overvoltage at the time of the generation of the carbon compound through the reduction of CO₂. Examples of such a material include at least one metal selected from Au, Ag, Cu, Pt, Pd, Ni, Zn, Cd, In, Sn, Co, Fe, and Pb, and an alloy containing at least one of these metals.

Near the second electrode layer 150, O₂ and H⁺ are generated through the oxidation of H₂O, for instance. Accordingly, where the second catalyst layer is formed on the second electrode layer 150, the second catalyst layer is formed of a material that reduces activation energy for oxidizing H₂O. In other words, this material lowers the overvoltage at the time of the generation of O₂ and H⁺ through the oxidation of H₂O. Specific examples of such a material are the same as those listed in the first embodiment, and include oxides of metals such as Ir, Ni, Co, Fe, Sn, In, Ru, La, Sr, Pb, and Ti.

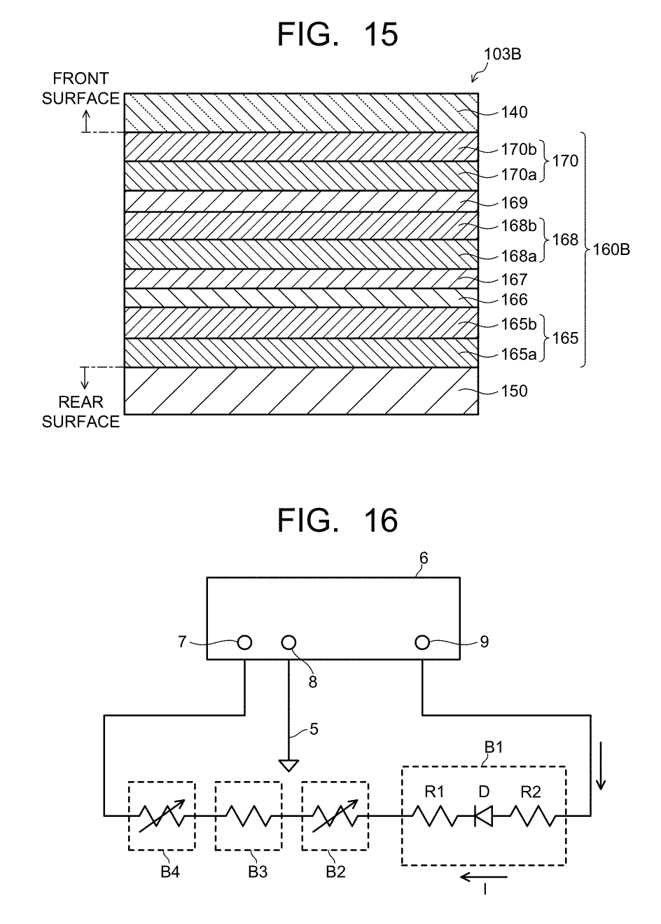

Specific configuration examples of the photovoltaic layer 160 and the stack 103 including the same will be described with reference to FIG. 14 and FIG. 15. FIG. 14 illustrates a stack 103A whose photovoltaic layer 160A is a nip junction silicon-based solar cell. The stack 103A illustrated in FIG. 14 is composed of a first electrode layer 140, a photovoltaic layer 160A, and a second electrode layer 150. A material of the second electrode layer 150 is the same metal material as that in the first embodiment. The second electrode layer 150 is a metal plate or an alloy plate.

The photovoltaic layer 160A is on the second electrode layer 150. The photovoltaic layer 160A is composed of a reflection layer 161, a first photovoltaic layer 162, a second photovoltaic layer 163, and a third photovoltaic layer 164. The reflection layer 161 is on the second electrode layer 150 and has a first reflection layer 161a and a second reflection layer 161b in sequence from the lower side. A material of the first reflection layer 161a is the same metal material as that in the first embodiment. The second reflection layer 161b is joined with a p-type semiconductor layer of the photovoltaic layer 160A and thus is preferably formed of a material having a light transmitting property and capable of ohmic contact with the p-type semiconductor layer. The material of the second reflection layer 161b is the same as that in the first embodiment.

The first photovoltaic layer 162, the second photovoltaic layer 163, and the third photovoltaic layer 164 are solar cells including nip junction of semiconductors and are different in light absorption wavelength. With these layers stacked in a planar state, the photovoltaic layer 160A can absorb lights in a wide wavelength range of the sunlight, enabling the efficient use of energy of the sunlight. The photovoltaic layer 160A has the series-connected photovoltaic layers 162, 163, 164 and thus can have a high open-circuit voltage.

The first photovoltaic layer 162 is on the reflection layer 161 and has a p-type-Si layer 162a, an intrinsic a-SiGe layer 162b, and an n-type Si layer 162c in sequence from the lower side. The a-SiGe layer 162b absorbs light in a long wavelength range of about 700 nm. In the first photovoltaic layer 162, charge separation is caused by energy of the light in the long wavelength range.

The second photovoltaic layer 163 is on the first photovoltaic layer 162 and has a p-type Si layer 163a, an intrinsic a-SiGe layer 163b, and a p-type Si layer 163c in sequence from the lower side. The a-SiGe layer 163b absorbs light in a middle wavelength range of about 600 nm. In the second photovoltaic layer 163, charge separation is caused by energy of the light in the middle wavelength range.

The third photovoltaic layer 164 is on the second photovoltaic layer 163 and has a p-type Si layer 164a, an intrinsic a-Si layer 164b, and an n-type Si layer 164c in sequence from the lower side. The a-Si layer 164b absorbs light in a short wavelength range of about 400 nm. In the third photovoltaic layer 164, charge separation is caused by energy of the light in the short wavelength range.

The first electrode layer 140 is on the n-type semiconductor layer (n-type Si layer 164c) of the photovoltaic layer 160A. Preferably, a material of the first electrode layer 140 has a light transmitting property and is capable of ohmic contact with the n-type semiconductor layer. Examples of the material of the first electrode layer 140 include transparent conductive oxides such as ITO, ZnO, FTO, AZO, and ATO. The first electrode layer 140 is not limited to a single layer of the transparent conductive oxide but may be, for example, a stack of the transparent conductive oxide layer and a metal layer or a layer of a composite of the transparent conductive oxide and another conductive material.

FIG. 15 illustrates a stack 103B whose photovoltaic layer 160B is an np-junction compound semiconductor-based solar cell. The stack 103B illustrated in FIG. 15 is composed of a first electrode layer 140, the photovoltaic layer 160B, and a second electrode layer 150. The functions, constituent materials, and so on of the first electrode layer 140 and the second electrode layer 150 are the same as those in the stack 103A illustrated in FIG. 14. The photovoltaic layer 160B includes a first photovoltaic layer 165, a buffer layer 166, a tunnel layer 167, a second photovoltaic layer 168, a tunnel layer 169, and a third photovoltaic layer 170.

The first photovoltaic layer 165 is on the second electrode layer 150 and has a p-type Ge layer 165a and an n-type Ge layer 165b in sequence from the lower side. The buffer layer 166 and the tunnel layer 167 containing GaInAs are on the first photovoltaic layer 165, for lattice matching and electrical junction with GaInAs forming the second photovoltaic layer 168. The second photovoltaic layer 168 is on the tunnel layer 167 and has a p-type GaInAs layer 168a and an n-type GaInAs layer 168b in sequence from the lower side. The tunnel layer 169 containing GaInP is on the second photovoltaic layer 168, for lattice matching and electrical junction with GaInP forming the third photovoltaic layer 170. The third photovoltaic layer 170 is on the tunnel layer 169 and has a p-type GaInP layer 170a and an n-type GaInP layer 170b in sequence from the lower side.

Next, a method of forming the first catalyst layer 141 on the first electrode layer 140 of the stack 103 will be described. The first catalyst layer 141 is electrochemically formed using the catalyst layer forming device 1 illustrated in FIG. 2. The catalyst layer forming device 1 illustrated in FIG. 2 is as previously described. The catalyst layer forming device 1 forms the first catalyst layer 141 by passing a current between the stack 104 and the counter electrode 4 which are immersed in the electrolytic solution 2, from the power source 6, and electrochemically precipitating at least one selected from a catalyst forming metal and a compound containing the catalyst forming metal onto the first electrode layer 140 of the stack 103. In forming the first catalyst layer 141, for example, the power source 6 controls the current flowing between the stack 103 and the counter electrode 4. In forming the first catalyst layer 141 on the first electrode layer 140, a potential applied across the stack 103 and the reference electrode 5 may be controlled.

The first electrode layer 140 is formed of the transparent conductive oxide having a high sheet resistance of about 10 to about 30Ω/□, while the second electrode layer 150 is formed of a metal material having a low sheet resistance of about several to about several ten mΩ/□. Accordingly, a wiring member 10 leading the current to the stack 103 is connected to the second electrode layer 150 as in the first embodiment. Connecting the wiring member 10 to the low-resistance second electrode layer 150 makes it possible to form the first catalyst layer 141 having in-plane uniformity on the first electrode layer 140. Outer peripheral surfaces of the stack 103 are covered with a protective member 11 except a part of the first electrode layer 140 where to form the first catalyst layer 141 so as to be insulated from the electrolytic solution 2. The wiring member 10 and the protective member 11 are the same as those of the first embodiment.

The electrolytic solution 2 is prepared. Where the first catalyst layer 141 formed of a reduction catalyst is formed on the first electrode layer 140, the electrolytic solution 2 is preferably an aqueous solution containing: at least one kind of ions selected from ions of the catalyst forming metal, oxide ions of the catalyst forming metal, and complex ions of the catalyst forming metal; and at least one kind of ions selected from hydroxide ions and inorganic acid ions. Specific examples of the inorganic acid ions are the same as those listed in the first embodiment. To adjust the conductivity of the electrolytic solution 2, a supporting electrolyte may be contained in the electrolytic solution 2.

The counter electrode 4, the reference electrode 5, and the stack 103 which are connected to the counter electrode terminal 7, the reference electrode terminal 8, and the working electrode terminal 9 of the power source 6 respectively are disposed in the electrolytic solution bath 3 filled with the electrolytic solution 2. While the counter electrode 4, the reference electrode 5, and the stack 104 are immersed in the electrolytic solution 2, the current is led to the stack 104 through the wiring member 10 connected to the second electrode layer 150. FIG. 16 is an equivalent circuit diagram of the step of forming the first catalyst layer 141 using the catalyst layer forming device 1. In FIG. 16, a block B1 is an equivalent circuit of the stack (photovoltaic cell) 103, a block B2 is an equivalent circuit representing an electrode reaction on the first electrode layer 140, a block B3 is an equivalent circuit representing the resistance of the electrolytic solution 2, a block B4 is an equivalent circuit representing an electrode reaction on the counter electrode 4, R1 is the resistance of the first electrode layer 140, R2 is the resistance of the second electrode layer 150, and D is the photovoltaic layer 160. Where the photovoltaic layer 160 has a plurality of nip junctions or np junctions, the equivalent circuit of the photovoltaic layer 160 is series connection of a plurality of diodes, but in FIG. 16, the plural series-connected diodes are equivalently represented by one diode.

As illustrated in FIG. 16, a forward bias is applied to the photovoltaic layer D to control the power source (potentiostat) 6 so that a forward current (indicated by the arrow in FIG. 16) flows in the photovoltaic layer D. That is, the current is passed between the counter electrode 4 and the stack 103 whose polarity is positive. The direction of the current is positive. When such a positive current is passed, a metal is precipitated from at least one kind of ions selected from the metal ions, the metal oxide ions, and the metal complex ions onto the first electrode layer 140. In the second embodiment, the photovoltaic layer 160 is forward-biased, which allows the wiring member 10 to be connected to the second electrode layer 150. This makes it possible to electrochemically form the first catalyst layer 141 having excellent in-plane thickness uniformity, on the first electrode layer 140.

### Third Embodiment

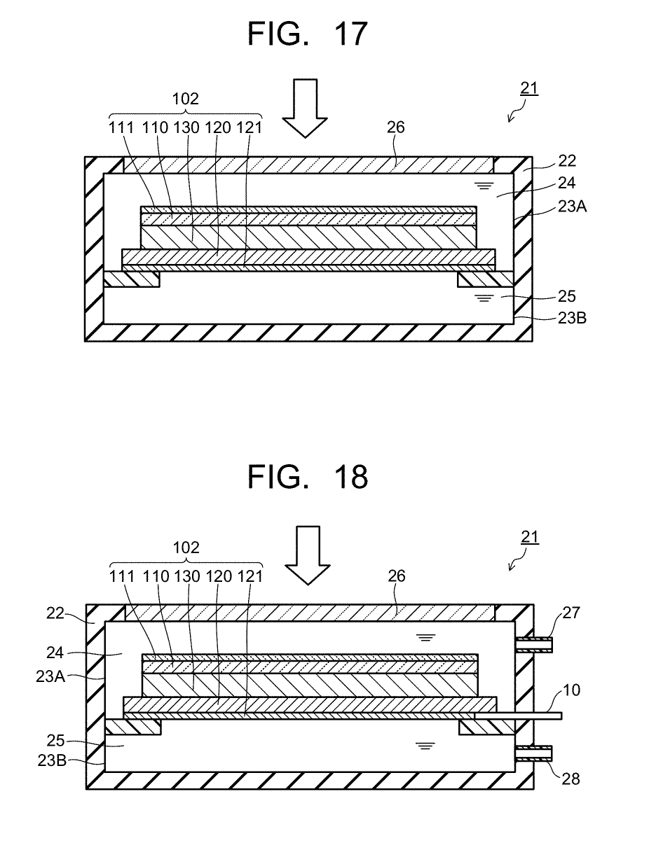

Next, a photoelectrochemical reaction device including the photoelectrode 102, 104 fabricated in the first or second embodiment will be described with reference to FIG. 17. Here, the photoelectrochemical reaction device including the photoelectrode 102 fabricated in the first embodiment will be mainly described. The photoelectrochemical reaction device including the photoelectrode 104 fabricated in the second embodiment also has the same basic structure as that of the photoelectrochemical reaction device including the photoelectrode 102 fabricated in the first embodiment except that the electrodes causing the oxidation reaction and the reduction reaction are reversed from those in the first embodiment.

FIG. 17 is a cross-sectional view illustrating a photoelectrochemical reaction device 21 including the photoelectrode 102 fabricated in the first embodiment. The photoelectrochemical reaction device 21 illustrated in FIG. 17 includes the photoelectrode 102 disposed in an electrolytic bath 22. The photoelectrode 102 illustrated in FIG. 17 has a second catalyst layer 121 on the second electrode layer 120. The photoelectrode 102 divides the electrolytic bath 22 into two chambers. The electrolytic bath 22 has a first solution chamber 23A filled with a first electrolytic solution 24 and a second solution chamber 23B filled with a second electrolytic solution 25. The first electrode layer 110 and the first catalyst layer 111 are exposed to the first electrolytic solution 24, and the second electrode layer 120 and the second catalyst layer 121 are exposed to the second electrolytic solution 25. The electrolytic bath 22 has a window member 26 having a light transmitting property to allow the irradiation of the photoelectrode 102 with external light.

The first solution chamber 23A and the second solution chamber 23B have an ion transfer pathway, not illustrated. The ion transfer pathway is an electrolytic solution path provided on a side of the electrolytic bath 22 or a plurality of thin holes (penetration holes) provided in the photoelectrode 102. The ion transfer pathway has an ion exchange membrane therein. The ion transfer pathway including the ion exchange membrane allows only specific ions (for example, H) to migrate between the first electrolytic solution 24 and the second electrolytic solution 25 while separating the first electrolytic solution 24 filled in the first solution chamber 23A and the second electrolytic solution 25 filled in the second solution chamber 23B from each other. Examples of the ion exchange membrane include cation exchange membranes such as Nafion and Flemion and anion exchange membranes such as Neosepta and Selemion. The ion transfer pathway may include a glass filter or agar therein. Where the first electrolytic solution 24 and the second electrolytic solution 25 are the same solution, the ion transfer pathway need not include the ion exchange membrane.

The first electrolytic solution 24 is a solution containing H₂O, and the second electrolytic solution 25 is a solution containing CO₂. In the photoelectrochemical reaction device 21 including the photoelectrode 104 fabricated in the second embodiment, the first electrolytic solution 24 is the solution containing CO₂, and the second electrolytic solution 25 is the solution containing H₂O. The solution containing H₂O is an aqueous solution containing a desired electrolyte. This solution is preferably an aqueous solution that promotes the oxidation reaction of H₂O. Examples of the electrolyte contained in the aqueous solution include phosphoric acid ions (PO₄²⁻), boric acid ions (BO₃³⁻), sodium ions (Na⁺), potassium ions (K⁺), calcium ions (Ca²⁺), lithium ions (Li⁺), cesium ions (Cs⁺), magnesium ions (Mg²⁺), chlorine ions (Cl⁻), hydrogen carbonate ions (HCO₃⁻), and carbonate ions (CO₃²⁻).

The solution containing CO₂ preferably has a high CO₂ absorptance. Examples of the solution containing H₂O include aqueous solutions containing LiHCO₃, NaHCO₃, KHCO₃, or CsHCO₃. The solution containing CO₂ may be alcohol such as methanol, ethanol, and acetone. The solution containing H₂O and the solution containing CO₂ may be the same solution, but since the solution containing CO₂ preferably has the high CO₂ absorptance and thus may be different from the solution containing H₂O. The solution containing CO₂ is desirably an electrolytic solution that lowers a CO₂ reduction potential, has a high ion conductivity, and contains a CO₂ absorbent that absorbs CO₂.

Examples of the aforesaid electrolytic solution include an ionic liquid that contains salt of cations such as imidazolium ions and pyridinium ions and anions such as BF₄⁻ and PF₆⁻ and is in a liquid form in a wide temperature range, and its aqueous solution. Other examples of the electrolytic solution include amine solutions of ethanolamine, imidazole, and pyridine, and aqueous solutions thereof. Amine may be any of primary amine, secondary amine, and tertiary amine. Examples of the primary amine include methylamine, ethylamine, propylamine, butylamine, pentylamine, and hexylamine. A hydrocarbon of the amine may be replaced with alcohol or halogen. Examples of the amine whose hydrocarbon is replaced include methanolamine, ethanolamine, and chloromethyl amine. Further, an unsaturated bond may exist. The same applies to hydrocarbons of the secondary amine and the tertiary amine.

Examples of the secondary amine include dimethylamine, diethylamine, dipropylamine, dibutylamine, dipentylamine, dihexylamine, dimethanolamine, diethanolamine, and dipropanolamine. The replaced hydrocarbons may be different. The same applies to the tertiary amine. Examples of amine in which replaced hydrocarbons are different include methylethylamine and methylpropylamine. Examples of the tertiary amine include trimethylamine, triethylamine, tripropylamine, tributylamine, trihexylamine, trimethanolamine, triethanolamine, tripropanolamine, tributanolamine, triexanolamine, methyldiethylamine, and methyldipropylamine. Examples of the cations of the ionic liquid include 1-ethyl-3-methylimidazolium ions, 1-methyl-3-propylimidazolium ions, 1-butyl-3-methylimidazole ions, 1-methyl-3-pentylimidazolium ions, and 1-hexyl-3-methyllimidazolium ions. The position 2 of the imidazolium ions may be replaced. Examples of the imidazolium ions whose position 2 is replaced include 1-ethyl-2,3-dimethylimidazolium ions, 1, 2-dimethyl-3-propylimidazolium ions, 1-butyl-2,3-dimethylimidazolium ions, 1,2-dimethyl-3-pentylimidazolium ions, and 1-hexyl-2,3-dimethylimidazolium ions. Examples of the pyridinium ions include methylpyridinium ions, ethylpyridinium ions, propylpyridinium ions, butylpyridinium ions, pentylpyridinium ions, and hexylpyridinium ions. In the imidazolium ions and the pyridinium ions, an alkyl group may be replaced, and an unsaturated bond may exist. Examples of the anions include fluoride ions, chloride ions, bromide ions, iodide ions, BF₄⁻, PF₆⁻, CF₃COO⁻, CF₃SO₃⁻, NO₃⁻, SCN⁻, (CF₃SO₂)₃C⁻, bis(trifluoromethoxysulfonyl)imide, bis(trifluoromethoxysulfonyl)imide, and bis(perfluoroethylsulfonyl)imide. Dipolar ions in which the cations and the anions of the ionic liquid are coupled by hydrocarbons may be used.

Next, an operation principle of the photoelectrochemical reaction device 21 will be described. Light radiated from above (the first electrode layer 110 side of) the photoelectrochemical reaction device 21 passes through the first catalyst layer 111 and the first electrode layer 110 to reach the photovoltaic layer 130. When absorbing the light, the photovoltaic layer 130 generates electrons and holes making pairs with the electrons and separates them. That is, in the photovoltaic layer 130, due to a built-in potential, the electrons migrate to the n-type semiconductor layer side (second electrode layer 120 side) and the holes generated as the pairs with the electrons migrate to the p-type semiconductor layer side (first electrode layer 110 side). This charge separation causes the generation of the electromotive force in the photovoltaic layer 130.

The holes which have been generated in the photovoltaic layer 130 and have migrate to the first electrode layer 110 are coupled with electrons generated by the oxidation reaction occurring near the first electrode layer 110 and the first catalyst layer 111. The electrons which have been generated in the photovoltaic layer 130 and have migrated to the second electrode layer 120 are used for the reduction reaction occurring near the second electrode layer 120 and the second catalyst layer 121. Specifically, near the first electrode layer 110 and the first catalyst layer 111 which are in contact with the first electrolytic solution 24, the reaction of the following formula (3) occurs. Near the second electrode layer 120 and the second catalyst layer 121 which are in contact with the second electrolytic solution 25, the reaction of the following formula (4) occurs.

2H₂O→4H⁺+O₂+4e⁻ (3)

2CO₂+4H⁺+4e⁻→2CO+2H₂O (4)

Near the first electrode layer 110 and the first catalyst layer 111, H₂O contained in the first electrolytic solution 24 is oxidized (loses electrons), so that O₂ and H⁺ are generated, as expressed by the formula (3). H⁺ generated on the first electrode layer 110 side migrates toward the second electrode layer 120 through the ion transfer pathway, not illustrated. Near the second electrode layer 120 and the second catalyst layer 121, CO₂ is reduced (gains electrons) as expressed by the formula (4). Specifically, CO₂ in the second electrolytic solution 25, H⁺ having migrated toward the second electrode layer 120 through the ion transfer pathway, and the electrons having migrated to the second electrode layer 120 react with one another, so that CO and H₂O are generated, for instance.

The photovoltaic layer 130 needs to have an open-circuit voltage equal to or more than a potential difference between a standard oxidation-reduction potential of the oxidation reaction occurring near the first electrode layer 110 and a standard oxidation-reduction potential of the reduction reaction occurring near the second electrode layer 120. For example, the standard oxidation-reduction potential of the oxidation reaction in the formula (1) is 1.23 V, and the standard oxidation-reduction potential of the reduction reaction in the formula (2) is −0.1 V. Accordingly, the open-circuit voltage of the photovoltaic layer 130 needs to be 1.33 V or more. The open-circuit voltage of the photovoltaic layer 130 is preferably equal to or more than the sum of the potential difference and overvoltages. Specifically, when the overvoltages of the oxidation reaction in the formula (1) and the reduction reaction in the formula (2) are both 0.2 V, the open-circuit voltage is desirably 1.73 V or more.

Near the second electrode layer 120, it is possible to cause not only the reduction reaction from CO₂ to CO expressed by the formula (2) but also a reduction reaction from CO₂ to, for example, formic acid (HCOOH), methane (CH₄), ethylene (C₂H₄), methanol (CH₃OH), ethanol (C₂H₅OH). It is also possible to cause a reduction reaction of H₂O contained in the second electrolytic solution 25 to generate H₂. Varying an amount of the water (H₂O) in the second electrolytic solution 25 can change a generated reduced substance of CO₂. For example, a generation ratio of CO, HCOOH, CH₄, C₂H₄, CH₃OH, C₂H₅OH, H₂, or the like can be changed.

The photoelectrochemical reaction device 21 of the embodiment can have higher conversion efficiency from, for example, the sunlight to the chemical energy, because its photoelectrode 102 has the first catalyst layer 111 excellent in thickness uniformity. As illustrated in FIG. 18, the photoelectrode 102 included in the photoelectrochemical reaction device 21 may include the wiring member 10, which is used for the formation of the first catalyst layer 111, as it is. The wiring member 10 is led out of the electrolytic bath 22. The electrolytic bath 22 illustrated in FIG. 18 further includes a first inlet 27 from which an electrode is put into the first solution chamber 23A and a second inlet 28 from which an electrode is put into the second solution chamber 23.

The photoelectrochemical reaction device 21 illustrated in FIG. 18 is capable of re-forming the first catalyst layer 111 when the first catalyst layer 111 deteriorates due to a long-time operation of the photoelectrode 102. For example, an Ag/AgCl reference electrode is put into the first inlet 27, and a counter electrode made of a Pt wire is put into the second inlet 28. The first electrolytic solution 24 stored in the first solution chamber 23A contains ions including the catalyst forming metal. A liquid inlet and a liquid outlet for the change of the electrolytic solution, and a gas outlet preventing a pressure rise, which are not illustrated, are provided in each of the first solution chamber 23A and the second solution chamber 23B of the electrolytic bath 22. As illustrated in FIG. 6, the wiring member 10 connected to the second electrode layer 120 is connected to the working electrode terminal 9 of the power source (potentiostat) 6, and the reference electrode and the counter electrode are connected to the reference electrode terminal 8 and the counter electrode terminal 9 respectively. A current is passed to the second electrode layer 120, whereby the catalyst layer 111 is re-formed on the first electrode layer 110. Such a mechanism can recover the performance of the photoelectrochemical reaction device 21.

The structure of each of the first to third embodiments may be combined with any of the other structures, and substitutions may be made in part thereof. While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A method for manufacturing an electrode, the method comprising:
preparing a stack comprising a first electrode layer, a second electrode layer comprising a metal electrode, and a voltaic layer disposed between the first electrode layer and the second electrode layer, the voltaic layer comprising a pin junction or a pn junction of semiconductors;
immersing the stack in an electrolytic solution comprising an ion comprising a metal constituting at least part of a catalyst layer which is to be formed on the first electrode layer; and
passing a current to the stack immersed in the electrolytic solution through the second electrode layer to electrochemically precipitate at least one selected from the group consisting of the metal and a compound comprising the metal, onto the first electrode layer.

2. The method of claim 1,
wherein the electrolytic solution comprises: at least one cation selected from the group consisting of an ion of the metal, an oxide ion of the metal, and a complex ion of the metal; and at least one anion selected from the group consisting of an inorganic acid ion and a hydroxide ion, and
wherein a counter electrode is immersed in the electrolytic solution to face the stack immersed in the electrolytic solution, and at least one selected from the group consisting of the metal, a hydroxide of the metal, and an oxide of the metal is precipitated onto the first electrode layer by passing the current between the counter electrode and the stack.

3. The method of claim 1, wherein the first electrode layer comprises a light transmitting electrode comprising a transparent conductive oxide, and the second electrode layer is formed of at least one metal selected from the group consisting of copper, aluminum, titanium, nickel, iron, and silver, or an alloy comprising the at least one metal.

4. The method of claim 3, wherein the transparent conductive oxide comprises at least one selected from the group consisting of indium tin oxide, zinc oxide, an aluminum-doped zinc oxide, tin oxide, a fluorine-doped tin oxide, an antimony-doped tin oxide, indium zinc oxide, and indium gallium zinc oxide.

5. The method of claim 1,
wherein the first electrode layer is an oxidation electrode which oxidizes water, and the second electrode layer is a reduction electrode which reduces at least one selected from the group consisting of carbon dioxide and water, and
wherein the catalyst layer comprises a metal oxide comprising at least one selected from the group consisting of manganese, iridium, nickel, cobalt, iron, tin, indium, ruthenium, lanthanum, strontium, lead, and titanium, as the metal.

6. The method of claim 5,
wherein the electrolytic solution comprises: at least one cation selected from the group consisting of an ion of the metal, an oxide ion of the metal, and a complex ion of the metal; and an anion being an inorganic acid ion, and
wherein a counter electrode is immersed in the electrolytic solution to face the stack immersed in the electrolytic solution, and at least one selected from the group consisting of a hydroxide of the metal and an oxide of the metal is precipitated onto the first electrode layer by passing the current between the counter electrode and the stack whose polarity is negative from a power source.

7. The method of claim 6,
wherein a hydroxide ion is generated through reduction of the inorganic acid ion by the current passed between the counter electrode and the stack,
wherein the hydroxide of the metal is precipitated onto the first electrode layer from the cation and the hydroxide ion, and
wherein the oxide of the metal is generated as the catalyst layer by heat treating the hydroxide of the metal precipitated onto the first electrode layer.

8. The method of claim 6, wherein the inorganic acid ion is at least one selected from the group consisting of a nitric acid ion, a sulfuric acid ion, a chloride ion, a phosphoric acid ion, a boric acid ion, a hydrogen carbonate ion, and a carbonate ion.

9. The method of claim 1, wherein the voltaic layer comprises at least one pin junction comprising a p-type semiconductor layer disposed on the first electrode layer side, an n-type semiconductor layer disposed on the second electrode layer side, and an i-type semiconductor layer disposed between the p-type semiconductor layer and the n-type semiconductor layer.

10. The method of claim 1, wherein the voltaic layer comprises at least one pn junction comprising a p-type semiconductor layer disposed on the first electrode layer side and an n-type semiconductor layer disposed on the second electrode layer side.

11. The method of claim 1,
wherein the first electrode layer is a reduction electrode which reduces at least one selected from the group consisting of carbon dioxide and water, and the second electrode layer is an oxidation electrode which oxidizes water, and
wherein the catalyst layer comprises at least one selected from the group consisting of gold, silver, copper, platinum, palladium, nickel, zinc, cadmium, indium, tin, cobalt, iron, and lead, as the metal.

12-15. (canceled)

16. The method of claim 1, wherein the method of manufacturing the electrode is a method of manufacturing a photoelectrode.
